(19) United States
(12) Patent Application Publication
(10) Pub. No.: US 2010/0261059 A1
(43) Pub. Date: Oct. 14, 2010

(54) COMPOSITE ANODE ACTIVE MATERIAL, ANODE INCLUDING THE COMPOSITE ANODE ACTIVE MATERIAL, LITHIUM BATTERY INCLUDING THE ANODE, METHOD OF PREPARING THE COMPOSITE ANODE ACTIVE MATERIAL

(75) Inventors: Dong-Min IM, Seoul (KR); Ha-su KIM, Seoul (KR); Hun-joon SOHN, Seoul (KR)

Correspondence Address: STEIN MCEWEN, LLP, 1400 EYE STREET, NW, SUITE 300, WASHINGTON, DC, 20005, US

(73) Assignees: Samsung SDI Co., Ltd., Suwon-si (KR); SNU R&D Foundation, Seoul (KR)

(21) Appl. No.: 12/759,825

(22) Filed: Apr. 14, 2010

(30) Foreign Application Priority Data
Apr. 14, 2009 (KR) 10-2009-0032341

(51) Int. Cl. H01M 4/38; H01M 4/02; H01B 1/02

(52) U.S. Cl. 429/220; 429/209; 252/503

(57) ABSTRACT

A composite anode active material including an intermetallic compound; carbon; and inorganic particles, an anode including the composite anode active material, a lithium battery employing the anode, and a method of preparing the anode active material.

### CROSS-REFERENCE TO RELATED APPLICATION

This application claims the benefit of Korean Patent Application No. 10-2009-0032341, filed on Apr. 14, 2009, in the Korean Intellectual Property Office, the disclosure of which is incorporated herein by reference.

### BACKGROUND

1. Field

One or more embodiments of the present invention relate to a composite anode active material, an anode including the composite anode active material, a lithium battery employing the anode, and a method of preparing the composite anode active material.

2. Description of the Related Art

Carbonaceous materials such as graphite are representative examples of anode active materials for lithium batteries. Graphite has excellent electrical capacity retention characteristics and excellent voltage characteristics. In addition, since graphite does not vary in volume when used to form an alloy with lithium, the stability of batteries can be increased. Graphite has a theoretical electrical capacity of about 372 mAh/g and a high irreversible capacity.

A metal that can form an alloy with lithium, a transition metal oxide, or an intermetallic compound may be used as an anode active material having higher electrical capacity than the carbonaceous material.

Examples of metals that can form alloys with lithium include silicon (Si), tin (Sn), and aluminum (Al). These metals that can form alloys with lithium have a very high electrical capacity, and undergo a change in volume during charging/discharging, thereby electrically isolating the active material within the electrode. In addition, the decomposition reaction of electrolytes becomes severe due to an increase in a specific surface area of the active material.

The transition metal oxide includes SnO, MoO₂, WO₂, or the like, minimizes the size of a transition metal and inhibit the aggregation of the transition metal during the charging/discharging to have excellent capacity retention characteristics. The transition metal oxide has low initial efficiency due to its irreversible capacity since LiO₂ is generated by a presence of oxygen.

The intermetallic compound may include a first element such as tin (Sn), bismuth (Bi), indium (In), zinc (Zn), silver (Ag), antimony (Sb), and lead (Pb), and a second element such as titanium (Ti), vanadium (V), chromium (Cr), manganese (Mn), iron (Fe), cobalt (Co), nickel (Ni), copper (Cu), niobium (Nb), molybdenum (Mo), and tungsten (W). Since the intermetallic compound does not contain oxygen atoms, Li₂O is not generated, thereby having high initial efficiency. The capacity retention characteristics of the intermetallic compound may deteriorate during the charging/discharging due to the aggregation of the first element.

There is still a need to develop an anode active material used to form a lithium battery having high capacity, high initial efficiency, and excellent capacity retention characteristics.

### SUMMARY

One or more embodiments of the present invention include a composite anode active material.

One or more embodiments of the present invention include an anode including the composite anode active material.

One or more embodiments of the present invention include a lithium battery including the anode.

One or more embodiments of the present invention include a method of preparing the composite anode active material.

According to one or more embodiments of the present invention, a composite anode active material includes: an intermetallic compound; carbon; and inorganic particles.

According to one or more embodiments of the present invention, an anode includes the composite anode active material.

According to one or more embodiments of the present invention, a lithium battery includes the anode.

According to one or more embodiments of the present invention, a method of preparing a composite anode active material includes mechanically milling an intermetallic compound, a carbonaceous material and inorganic particles in an inert atmosphere.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a graph showing X-ray diffraction (XRD) test results of an intermetallic compound prepared according to Preparation Example 1;

FIG. 2 is a graph showing XRD test results of a composite anode active material prepared according to Example 1;

FIG. 3 is a graph showing XRD test results of a composite anode active material prepared according to Example 2;

FIG. 4 is a high resolution transmission electron microscopic (HR-TEM) image of a composite anode active material prepared according to Example 1; and

FIG. 5 shows selected area diffraction pattern (SADP) of a composite anode active material prepared according to Example 1.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, a composite anode active material according to an embodiment of the present invention will be described in greater detail.

A composite anode active material according to an embodiment of the present invention includes an intermetallic compound; carbon; and inorganic particles. The composite anode active material comprises inorganic particles with high hardness. Thus, intermetallic particles may be pulverized to have a finer size during a process of preparing the composite anode active material. In addition, the inorganic particles may inhibit the intermetallic compound dispersed in the composite anode active material from aggregating during charging/discharging.

According to an embodiment of the present invention, the intermetallic compound of the composite anode active material may include tin (Sn), as a first element; and one selected from the group consisting of titanium (Ti), vanadium (V), chromium (Cr), manganese (Mn), iron (Fe), cobalt (Co), nickel (Ni), copper (Cu), niobium (Nb), molybdenum (Mo), and tungsten (W) as a second element. For example, the intermetallic compound may include at least one selected from the group consisting of Sn₂Fe, SnFe, SnTi₂, Sn₂Co, SnCo, and Sn₅Cu₆. The intermetallic compound may react with lithium. In addition, since an amount of lithium that can react with the intermetallic compound per unit weight of the intermetallic compound is large, the capacity of a battery may increase.

According to an embodiment of the present invention, the amount of carbon of the composite anode active material may be equal to or less than 20% by weight based on the total weight of the composite anode active material. For example, the amount of carbon may be in the range of about 1 to about 20% by weight. Due to high conductivity, carbon functions as a pathway of electrons and lithium ions in the composite anode active material. In addition, the carbon functions as a lubricant when the composite anode active material is prepared by mechanical milling to easily disperse each element. For example, the composite anode active material may have a structure in which the intermetallic compound and the inorganic particles are finely dispersed in a carbon matrix. Any carbon obtained from carbonaceous materials that are commonly used in the art may be used without limitation. For example, examples of the carbon include graphite, carbon black, amorphous carbon, and fibrous carbon.

The Mohs hardness of the inorganic particles in the composite anode active material may be equal to or greater than 8.5. For example, the Mohs hardness of the inorganic particles may be in the range of about 8.5 to about 10. The inorganic particles may be a metal oxide, a metal nitride, a metal carbide, or the like, but are not limited thereto. For example, the inorganic particles may include at least one selected from the group consisting of alumina (Al₂O₃), silicon carbide (SiC), tungsten carbide (WC), diamond (C), and fullerene (C). For example the fullerene can be C60, C70, C76, C84, etc.

The amount of the inorganic particles in the composite anode active material may be equal to or less than 5% by weight of the total weight of the composite anode active material. For example, the amount of the inorganic particles may be in the range of about 5 to about 0.1% by weight.

One or more embodiments of the present invention include an anode including the composite anode active material. For example, the anode may be manufactured by molding an anode active material composition including the composite anode active material and a binder into a desired shape, or by coating the anode active material composition on a current collector such as Cu foil, or the like.

In particular, the anode active material composition comprising the composite anode active material, a conducting agent, a binder, and a solvent is prepared, and then directly coated on a Cu foil current collector to obtain an anode plate. Alternatively, the anode active material composition may be cast on a separate support, and then an anode active material film separated from the support is laminated on the Cu foil current collector to obtain an anode plate. The preparation of the anode active material composition is not limited to the examples described above, and may be prepared differently.

For high capacity batteries, a large amount of current is charged and discharged, and thus a material having low electrical resistance is used. Any kind of conducting agent that reduces the resistance of an electrode may be added to the anode. In this regard, the conducting agent that is mainly used may be carbon black, graphite particulates, or the like.

Examples of the binder include a vinylidene fluoride/hexafluoropropylene copolymer, polyvinylidene fluoride (PVDF), polyacrylonitrile, polymethylmethacrylate, polytetrafluoroethylene, mixtures of these materials, and a styrene butadiene rubber polymer. The solvent may include N-methyl-pyrrolidone, acetone, water, or the like. Here, the amounts of the anode electrode active material, the conducting agent, the binder, and the solvent used in the manufacture of the lithium battery are amounts generally used in the art.

One or more embodiments of the present invention include a lithium battery employing the anode including the composite anode active material. The lithium battery may be manufactured in the following manner.

First, a cathode active material, a conducting agent, a binder, and a solvent are mixed to prepare a cathode active material composition. The cathode active material composition is directly coated on a metallic current collector and dried to prepare a cathode plate. Alternatively, the cathode active material composition may be cast on a separate support, and then a cathode active material film separated from the support is laminated on a metallic current collector to prepare a cathode plate.

A lithium-containing metal oxide that is commonly used in the art may be used as the cathode active material. Examples of the lithium-containing metal oxide include LiCoO₂, LiMnxO₂x where x=1 or 2, LiNi1-xMnxO₂ where 0<x<1, or LiNi1-x-yCoxMnyO₂ where 0≦x≦0.5 and 0≦y≦0.5. The lithium-containing metal oxide may also include compounds capable of intercalation and deintercalation of lithium ions, such as LiMn₂O₄, LiCoO₂, LiNiO₂, LiFeO₂, V₂O₅, TiS, MoS₂, or the like. The conducting agent may include carbon black or graphite particulates. Examples of the binder include a vinylidene fluoride/hexafluoropropylene copolymer, polyvinylidene fluoride (PVDF), polyacrylonitrile, polymethylmethacrylate, polytetrafluoroethylene, mixtures of these materials, and a styrene butadiene rubber polymer. The solvent may include N-methyl-pyrrolidone, acetone, water, or the like. Here, the amounts of the cathode electrode active material, the conducting agent, the binder, and the solvent used in the manufacture of the lithium battery are amounts generally used in the art.

A separator used in the lithium battery may be any separator that is commonly used for lithium batteries. The separator may have low resistance to the migration of ions in an electrolyte and have an excellent electrolyte-retaining ability. Examples of the separator may include glass fiber, polyester, Teflon, polyethylene, polypropylene, polytetrafluoroethylene (PTFE), a combination thereof, and a material which may be in non-woven or woven fabric form. In particular, a windable separator including polyethylene, polypropylene or the like may be used for a lithium ion battery. A separator that retains a large amount of an organic electrolytic solution may be used for a lithium-ion polymer battery. These separators may be manufactured using the following method.

A polymer resin, a filler and a solvent are mixed to prepare a separator composition. The separator composition is directly coated on an electrode, and then dried to form a separator film. Alternately, the separator composition may be cast onto a separate support, dried, detached from the separate support, and finally laminated on an upper portion of the electrode, thereby forming a separator film.

Any polymer resin that is commonly used for binding electrode plates in lithium batteries may be used without limitation. Examples of the polymer resin may include a vinylidenefluoride/hexafluoropropylene copolymer, polyvinylidene fluoride (PVDF), polyacrylonitrile, polymethylmethacrylate and any mixture thereof.

An electrolytic solution used in the lithium battery is prepared by dissolving an electrolyte in a solvent. The solvent may be selected from the group consisting of propylene carbonate, ethylene carbonate, fluoroethylene carbonate, diethyl carbonate, methylethyl carbonate, methylpropyl carbonate, butylene carbonate, benzonitrile, acetonitrile, tetrahydrofuran, 2-methyltetrahydrofuran, y-butyrolactone, dioxolane dioxorane, 4-methyldioxorane, N,N-dimethyl formamide, dimethyl acetamide, dimethylsulfoxide, dioxane, 1,2-dimethoxyethane, sulfolane, dichloroethane, chlorobenzene, nitrobenzene, dimethyl carbonate, methyl isopropyl carbonate, ethylpropyl carbonate, dipropyl carbonate, dibutyl carbonate, diethylene glycol, dimethyl ether, and mixtures thereof. The electrolyte may be a lithium salt, such as LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CxF₂x+1SO₂)(CyF₂y+1SO₂) where x and y are each independently a natural number, LiCl, Lil, or mixtures thereof.

The separator is interposed between the cathode plate and the anode to form a battery assembly. The battery assembly is wound or folded and then sealed in a cylindrical or rectangular battery case. Then, the electrolyte solution described above is injected into the battery case to complete the manufacture of a lithium battery. Alternatively, the battery assembly is stacked in a bi-cell structure and impregnated with the electrolyte solution. The resultant is put into a pouch and hermetically sealed, thereby completing the manufacture of a lithium ion polymer battery.

One or more embodiments include a method of preparing a composite anode active material, the method including: mechanically milling an intermetallic compound, a carbonaceous material and inorganic particles in an inert atmosphere. According to the method, an intermetallic compound, a carbonaceous material, and inorganic particles which are separately prepared in powder form are mechanically milled in a mixer in an inert atmosphere.

The method may further include preparing the intermetallic compound by mixing tin (Sn), as a first metal, and one selected from the group consisting of titanium (Ti), vanadium (V), chromium (Cr), manganese (Mn), iron (Fe), cobalt (Co), nickel (Ni), copper (Cu), niobium (Nb), molybdenum (Mo), and tungsten (W), as a second metal, and heat-treating the mixture at a temperature in the range of about 400 to about 600° C.

The intermetallic compound may include at least one selected from the group consisting of Sn₂Fe, SnFe, SnTi₂, Sn₂Co, SnCo, and Sn₅Cu₆.

The carbonaceous material may include at least one selected from the group consisting of graphite, carbon black, amorphous carbon, fibrous carbon and any mixture thereof.

The inorganic particles may have a Mohs hardness that is equal to or greater than 8.5. For example, the Mohs hardness of the inorganic particles may be in the range of about 9.0 to about 10.

The inorganic particles include at least one selected from the group consisting of alumina (Al₂O₃), silicon carbide (SiC), tungsten carbide (WC), diamond (C), and fullerene (C).

Hereinafter, one or more embodiments of the present invention will be described in detail with reference to the following examples. However, these examples are not intended to limit the purpose and scope of the one or more embodiments of the present invention.

Preparation of Intermetallic Compound

### PREPARATION EXAMPLE 1

Sn (Aldrich, 325 mesh, 99.8%) in powder form and Fe (Aldrich, 10 μm, 99.9%) in powder form were mixed to a molar ratio of 2:1, and the mixture was heat-treated at 450° C. for 12 hours in argon (Ar) atmosphere to obtain a single phase Sn₂Fe intermetallic compound in powder form.

Preparation of Composite Anode Active Material

### EXAMPLE 1

2.46 g of Sn₂Fe prepared in Preparation Example 1 in powder form; 0.45 g of carbon black (Superp, MMM carbon, Belgium) in powder form; and 0.09 g of alumina (Al₂O₃) having a Mohs hardness of 9 in powder form were mixed, and the mixture was mechanically milled at 500 rpm for 40 hours in Ar atmosphere using a self-manufactured shaker-mill type ball mill to prepare a composite anode active material.

### EXAMPLE 2

2.46 g of Sn₂Fe prepared in Preparation Example 1 in powder form; 0.45 g of carbon black (Superp, MMM carbon, Belgium) in powder form; and 0.09 g of silicon carbide (SiC) having a Mohs hardness of 9 in powder form were mixed, and the mixture was mechanically milled at 500 rpm for 40 hours in Ar atmosphere using a self-manufactured shaker-mill type ball mill to prepare a composite anode active material.

### COMPARATIVE EXAMPLE 1

2.55 g of Sn₂Fe prepared in Preparation Example 1 in powder form and 0.45 g of carbon black (Superp, MMM carbon, Belgium) in powder form were mixed, and the mixture was mechanically milled at 500 rpm for 40 hours in Ar atmosphere using a self-manufactured shaker-mill type ball mill to prepare a composite anode active material.

### COMPARATIVE EXAMPLE 2

2.46 g of Sn₂Fe prepared in Preparation Example 1 in powder form; 0.45 g of carbon black (SuperP, MMM carbon, Belgium) in powder form, and 0.09 g of TiO₂ (Aldrich, 325 mesh, >99%) in powder form that has anatase phase with a Mohs hardness of 6 were mixed, and the mixture was mechanically milled at 500 rpm for 40 hours in Ar atmosphere using a self-manufactured shaker-mill type ball mill to prepare a composite anode active material.

### COMPARATIVE EXAMPLE 3

2.46 g of Sn₂Fe prepared in Preparation Example 1 in powder form; 0.45 g of carbon black (SuperP, MMM carbon, Belgium) in powder form, and 0.09 g of crystalline SiO₂ (Aldrich, 325 mesh, 99.6%) in powder form that has a Mohs hardness of 7 were mixed, and the mixture was mechanically milled at 500 rpm for 40 hours in Ar atmosphere using a self-manufactured shaker-mill type ball mill to prepare a composite anode active material.

Manufacture of Anode and Lithium Battery

### EXAMPLE 3

70% by weight of the anode active material prepared in Example 1 in powder form, 15% by weight of a graphite in powder form, and 15% by weight of polyvinylidene fluoride (PVDF), and 10 times the weight of N-methylpyrrolidone (NMP) based on the weight of PVDF were mixed in an agate mortar to prepare a slurry. The slurry was coated on a Cu foil to a thickness of about 40 μm using a doctor blade. Then, the resultant was dried at room temperature for 2 hours, and then dried again at 120° C. in a vacuum for 2 hours to manufacture an anode plate.

The anode plate, a lithium metal constituting a counter electrode, a polypropylene layer (Cellgard 3501) constituting a separator, and an electrolyte solution obtained by dissolving 1 M of LiPF₆ in a mixed solvent of ethylene carbonate (EC) and diethylene carbonate (DEC) (weight ratio of 3:7) were used to manufacture a CR-2016 standard coin cell.

### EXAMPLE 4

A coin cell was manufactured in the same manner as in Example 3, except that the anode was manufactured using the anode active material of Example 2 instead of the anode active material of Example 1.

### COMPARATIVE EXAMPLE 4

An anode and a lithium battery were manufactured in the same manner as in Example 3, except that the anode active material prepared in Comparative Example 1 was used instead of the anode active material prepared in Example 1.

### COMPARATIVE EXAMPLE 5

An anode and a lithium battery were manufactured in the same manner as in Example 3, except that the anode active material prepared in Comparative Example 2 was used instead of the anode active material prepared in Example 1.

### COMPARATIVE EXAMPLE 6

An anode and a lithium battery were manufactured in the same manner as in Example 3, except that the anode active material prepared in Comparative Example 3 was used instead of the anode active material prepared in Example 1.

### EVALUATION EXAMPLE 1

### X-ray Diffraction Test

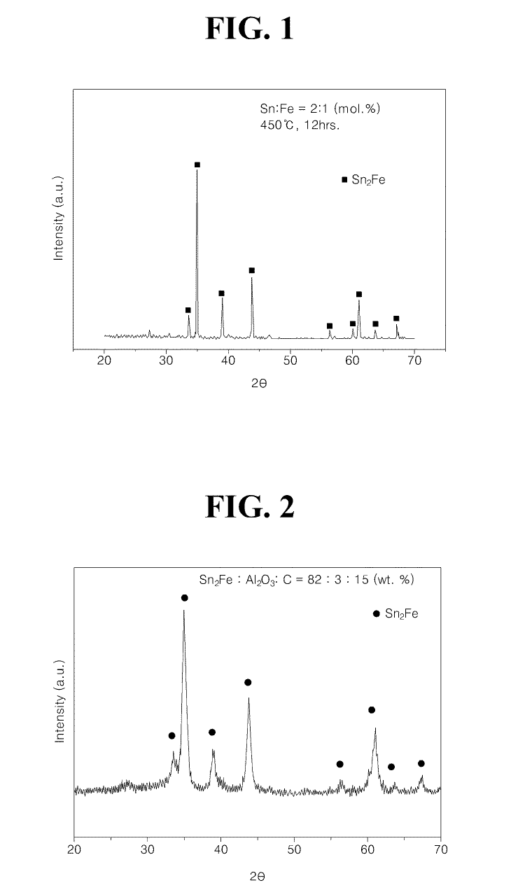

X-ray diffraction tests were performed on the Sn₂Fe intermetallic compound prepared according to Preparation Example 1 and the composite anode active materials prepared in Examples 1 and 2 in powder form. The results are shown in FIGS. 1 through 3.

Referring to FIG. 1, it was identified that the Sn₂Fe intermetallic compound was prepared in Preparation Example 1.

Referring to FIG. 2, it was identified that the composite anode active material prepared according to Example 1 includes a small amount of carbon based on a diffraction peak at about 27° and the Sn₂Fe was in a single phase.

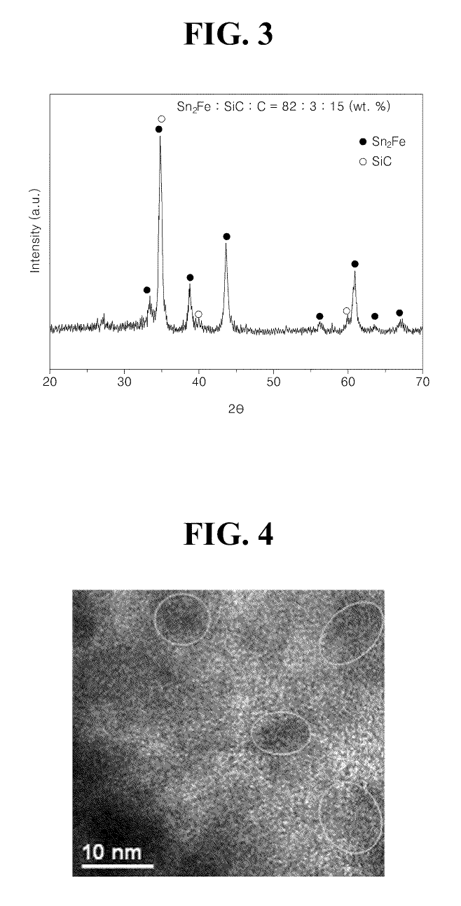

Referring to FIG. 3, it was identified that the composite anode active material prepared according to Example 2 includes Sn₂Fe and SiC.

### EVALUATION EXAMPLE 2

### Transmission Electron Microscopic (TEM) Test and Selected Area Electron Diffraction (SAED) Test

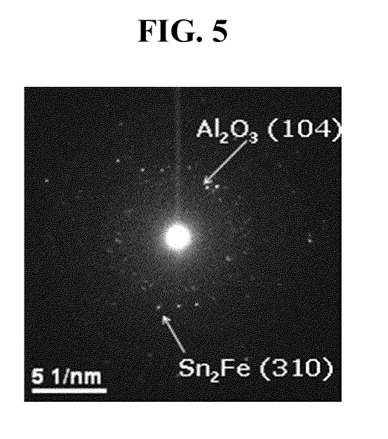

TEM images of the composite anode active material prepared according to Example 1 in powder form was obtained and an SAED test was performed on the composite anode active material of Example 1. The results are shown in FIGS. 4 and 5.

Referring to FIG. 4, the composite anode active material prepared according to Example 1 includes a Sn₂Fe domain represented as circles in FIG. 4.

Referring to FIG. 5, the composite anode active material includes alumina.

### EVALUATION EXAMPLE 3

### Charge-Discharge Test

The lithium batteries manufactured according to Examples 3 and 4 and Comparative Example 4 to 6 were charged until the voltage thereof reached 0.001 V (with respect to Li) by flowing a current of 50 mA per 1 g of the anode active material, and then discharged at the same current flow rate until the voltage reached 1.5 V (with respect to Li).

Then, the cycle of charging and discharging was repeated 50 times at the same current flow rate to the same voltage. The results are shown in Table 1 below.

TABLE 1

| | | | Capacity retention |
|---|---|---|---|
| | Initial capacity | Initial efficiency | rate at 30^{th} charge- |
| | [mAh/g] | [%] | discharge cycle [%] |
| Example 3 | 654 | 80 | 89 |
| Example 4 | 644 | 75 | 88 |
| Comparative | 705 | 73 | 75 |
| Example 4 | | | |
| Comparative | 578 | 67 | 73 |
| Example 5 | | | |
| Comparative | 642 | 72 | 74 |
| Example 6 | | | |

Referring to Table 1, the lithium batteries manufactured according to Examples 3 and 4 using the composite anode active material according to embodiments of the present invention had higher initial efficiency and capacity retention rate than the lithium battery manufactured according to Comparative Example 4 to 6.

The initial capacity of the lithium batteries according to Examples 3 and 4 is relatively lower than that of Comparative Example 2. However, the initial capacity of the lithium batteries according to Examples of 3 and 4 is similar to that of Comparative Example 2 in consideration of the amount of inorganic particles used in the composite anode active material prepared according to Examples 1 and 2, and rather high with respect to the carbonaceous anode active material.

According to one or more embodiments of the present invention, lithium batteries may have excellent initial efficiency and high capacity retention rate using a composite anode active material including inorganic particles.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A composite anode active material comprising:
an intermetallic compound;
carbonaceous material; and
inorganic particles.

2. The composite anode active material of claim 1, wherein the intermetallic compound comprises:
tin (Sn); and
an element selected from the group consisting of titanium (Ti), vanadium (V), chromium (Cr), manganese (Mn), iron (Fe), cobalt (Co), nickel (Ni), copper (Cu), niobium (Nb), molybdenum (Mo), and tungsten (W).

3. The composite anode active material of claim 1, wherein the intermetallic compound comprises at least one selected from the group consisting of Sn₂Fe, SnFe, SnTi₂, Sn₂Co, SnCo, and Sn₅Cu₆.

4. The composite anode active material of claim 1, wherein an amount of the carbonaceous material is equal to or less than 20% by weight of a total amount of the composite anode active material.

5. The composite anode active material of claim 1, wherein a Mohs hardness of the inorganic particles is equal to or greater than 8.5.

6. The composite anode active material of claim 1, wherein the inorganic particles comprise one selected from the group consisting of a metal oxide, a metal nitride, and a metal carbide.

7. The composite anode active material of claim 1, wherein the inorganic particles comprise at least one selected from the group consisting of alumina (Al₂O₃), silicon carbide (SiC), tungsten carbide (WC), diamond (C), and fullerene (C).

8. The composite anode active material of claim 1, wherein an amount of the inorganic particles is equal to or less than 5% by weight of a total amount of the composite anode active material.

9. The composite anode active material of claim 1, wherein the carbonaceous material comprises at least one selected from the group consisting of graphite, carbon black, amorphous carbon, fibrous carbon, and any mixture thereof.

10. An anode comprising the composite anode active material of claim 1.

11. A lithium battery including the anode of claim 10.

12. A method of preparing a composite anode active material, the method comprising:
mechanically milling an intermetallic compound, a carbonaceous material and inorganic particles in an inert atmosphere.

13. The method of claim 12, further comprising preparing the intermetallic compound by mechanically milling tin (Sn); and one metal selected from the group consisting of titanium (Ti), vanadium (V), chromium (Cr), manganese (Mn), iron (Fe), cobalt (Co), nickel (Ni), copper (Cu), niobium (Nb), molybdenum (Mo), and tungsten (W) in the inert atmosphere.

14. The method of claim 12, wherein the intermetallic compound comprises at least one selected from the group consisting of Sn₂Fe, SnFe, SnTi₂, Sn₂Co, SnCo, and Sn₅Cu₆.

15. The method of claim 12, wherein the carbonaceous material comprises at least one selected from the group consisting of graphite, carbon black, amorphous carbon, fibrous carbon, and any mixture thereof.

16. The method of claim 12, wherein a Mohs hardness of the inorganic particles is equal to or greater than 8.5.

17. The method of claim 12, wherein the inorganic particles comprise at least one selected from the group consisting of alumina (Al₂O₃), silicon carbide (SiC), tungsten carbide (WC), diamond (C), and fullerene (C).
